(19) United States
(12) Patent Application Publication
(10) Pub. No.: US 2010/0215953 A1
(43) Pub. Date: Aug. 26, 2010

(54) METHOD OF MANUFACTURING A COMPOSITE, ESPECIALLY A BULLETPROOF COMPOSITE, AND COMPOSITE OBTAINED

(76) Inventors: Francois Boussu, Roubaix (FR); Virginie Begus, Mereville (FR)

Correspondence Address: LADAS & PARRY LLP, 224 SOUTH MICHIGAN AVENUE, SUITE 1600, CHICAGO, IL, 60604, US

(21) Appl. No.: 12/663,073

(22) PCT Filed: Jun. 5, 2008
(86) PCT No.: PCT/FR2008/051009

§ 371 Date: Mar. 15, 2010

(30) Foreign Application Priority Data
Jun. 6, 2007 (FR) 0755511

(51) Int. Cl. B32B 27/34; D03D 15/00; D03D 49/50

(52) U.S. Cl. 428/340; 428/221; 139/426 TW; 139/116.1

(57) ABSTRACT

The subject of the present invention is a method of manufacturing a composite (8) comprising a textile reinforcement (7) and a polymer matrix, especially a bulletproof composite. Said method characteristically comprises: a step of forming the textile reinforcement (7) by 2.5D weaving of first yarns with second yarns in a defined weave (A_{1/1}), said second yarns being of a thermosetting polymer and said first yarns being high-performance yarns, so as to obtain an interlock fabric (7); and then a heat treatment during which said interlock fabric (7) is subjected to specified temperature and pressure conditions so as to melt said second yarns in order to form the polymer matrix, without impairing the first yarns.

### FIELD OF THE DISCLOSURE

The present invention is in the technical field of composite materials for structural applications, and more particularly for bulletproof protection.

### BACKGROUND OF RELATED ART

Ballistics distinguishes two types of impact, low-energy impact and high-energy impact. The kinetic energy developed by a given projectile is determined by the following equation: Ec=½ mv² (Joules) where m and v correspond respectively to mass in Kg and velocity in m/s of said projectile.

The low-energy impact energy corresponds to impacts caused by side arms ammunition and sporting guns utilising non-perforating bullets with a soft core, the calibres of which extend from around 0.22 inch to 0.44 inch. Structures mainly used against this type of impact are called soft protections, constructed from a succession of layers of fabric, UD (UniDirectional) or even nonwoven fabrics connected by seams in the shape of checkerboard, diamond or cross.

The high-energy impact corresponds to impacts caused by combat weapons ammunition, such as assault rifles such as Famas and Kalashnikov (calibre 5.56 mm, 7.62 mm, . . . ) or heavy machineguns (calibre 12.7 mm) fitted on planes, tanks, . . . Bullets known as “perforating” have an internal ogive made of very hard and very dense metal (tungsten, hardened steel for example). Bulletproof protection focussing on perforating and combat weapons ammunition requires the use of two types of hard protection: monolayer shielding consisting of composite material only and bilayer shielding consisting of a composite associated with a ceramic plate or a composite and a steel plate. Ceramics are used in the field of ballisticproof protection for their low surface mass compared to that of metallic plates and their substantial hardness. The face of the ceramic plate exposed to impact tends to fragment hard-cored ammunition of perforating bullets and reduces the kinetic energy associated with this impact. In this case, the composite material absorbs the kinetic energy by deformation of its fibrous structure, i.e. its reinforcement, and intercepts the fragments.

These projectiles can be bullets, rockets or even fragments of the latter. There is a multitude of projectiles (shielded, perforating, expanding bullets, . . . ) which differ by their mass, form (ogive, spherical, . . . ), the material they are made of (lead, hardened steel, . . . ) and especially their impact velocity.

In the state of the art composite materials for bulletproof protection, and especially protection for high-energy impacts, are formed from superposition of textile layers, knitted fabric, woven fabric, nonwoven fabric, UniDirectional reinforcement, “Non Crimp Fabric” or NCF corresponding to fabrics without shrinkage) optionally with inorganic layers, embedded in a matrix, such as epoxy resin.

The matrix in these materials is incorporated via liquid, for example by the “RTM” process (Resin Transfer Moulding), or via gas. The textile reinforcements used can also be pre-impregnated, known as prepegs.

In the case of textiles in two dimensions, during impact, the shockwave spreads in the yarns by coupling to the binding points, that is, to the intersecting points between the yarns. The energy is thus dissipated in more yarns and therefore over a larger surface. However, at the binding points the waves are reflected and are superposed, causing elongation of the yarns forming the textile reinforcement until they break. The textile structures in two dimensions have a loss of charge following impact due to binding.

Therefore, the textile reinforcements of the composite materials are oriented in a single direction to eliminate binding points. These are unidirectional reinforcements in which the long fibres, arranged parallel to one another and in the same plane, are embedded in a matrix. It is also possible to orient the layers relative to one another according to different angles (0°, 45°, 90°, . . . ) to improve the distribution and transfer of energy in the composite. For commercial reasons the UD plies proposed in the commercially available composites are oriented at 0°/190°.

Documents FR 2.610.951 and FR 2.819.804 describe intermediate reinforcement woven between a 2D reinforcement (the fibres are oriented in two directions) and 3D reinforcement (the fibres are oriented in three directions), which the person skilled in the art refers to as “2.5D”. The resulting fibrous 2.5D armatures or reinforcement are appropriate for making thin structures equivalent to a 2D stack, and having excellent resistance to delamination as a 3D.

Also known is a composite whereof the textile reinforcement comprises plies of fabrics obtained according to an orthogonal weaving technique developed by the company 3Tex® and described in EP 1.386.028 B1. This weaving technique attenuates the delamination observed in the laminated composites of 2D or UD plies, and reduces the number of necessary plies.

Resistance to delamination is primordial for shielding materials, especially in the case of multi-impact shots, since the integrity of their structure is threatened. However, delamination of shielding materials following impact must not be eliminated. In fact, controlled delamination favours absorption of the kinetic energy due to impact.

The aim of the present invention is a manufacturing process of a composite material producing a composite material having improved delamination performance, a lower surface mass than the surface mass of commercially available composites with equivalent performances, less expensive and simpler to make.

The aim of the present invention is a manufacturing process of a composite material, comprising a textile reinforcement and a polymer matrix, especially for ballisticproof protection, and characteristically comprising:

a) a step for forming the textile reinforcement by 2.5D weaving of first yarns with second yarns according to a determined weave, said second yarns being made of thermofusible polymer and said first yarns being high-performance yarns, so as to produce an interlock fabric,

b) followed by thermal processing during which said interlock fabric is subjected to temperature and pressure conditions determined so as to melt said second yarns to form the polymer matrix, without altering said first yarns.

2.5D weaving designates the weaving technique which produces fabrics called “interlock warp” or 2.5D, which can be made on a conventional weaving loom and enabling the introduction of yarns in the thickness of multi-layer fabric. The fabric interlock warp is in the form of a multi-layer fabric whereof the binding between the superposed layers is ensured by warp yarns. The weaving technique utilised is that of multiwarp weaving on a warp and weft loom during which opening the shed is unidirectional, contrary to 3-dimensional weaving. Interlock fabrics can be woven on all types of weaving looms adapted to receive layers of warp yarns necessary for making said fabrics. The number of layers of warp yarns is a function of the number of shafts available on the loom and of the width connection of the selected weave. 2.5D fabrics are adapted for making thin structures as there are no inter-layer cavities such as in a three-dimensional fabric (3D). This arrangement optimises the quantity of polymer matrices and helps produce light composite materials.

2.5D fabric is a multilayer fabric comprising at least three layers or plies.

The temperature T₀ of the thermal processing is preferably between the melting temperature of the second yarns T_{f2} and the melting temperature of the first yarns T_{f1}, T_{f1} being greater than T_{f2}, such that the first yarns are unimpaired.

Advantageously, the second yarns can be inserted in warp or in weft, over the entire thickness, width and length of the interlock fabric, such that during said thermal processing the melted polymer resulting from said second yarns core-impregnate said first yarns, and this in spite of the sometimes considerable thickness of the interlock fabric. Said first yarns are impregnated at the core and surface of the polymer matrix.

Advantageously, by weaving two groups of distinct yarns, it is easy to adjust the quantity and arrangement of the second yarns in the 2.5D fabric so as to optimise the weight of the final polymer matrix in said composite material and the quality of the core impregnation of the first yarns.

The selected weaving pattern, the number of layers of the interlock fabric and the nature of the second yarns are determined as a function of the application of the composite material. The second yarns can be multi-component yarns, plated yarns, spun yarns and/or multi-filament yarns.

The first yarns are preferably monofilaments or multifilament yarns made of high-performance polymer.

Incorporation of the polymer matrix in the form of thermofusible yarns during the weaving step cancels the incorporation step of the matrix by liquid or gas subsequent to the step for forming the textile reinforcement in the prior art. Also, since the quality of the impregnation using these techniques is not satisfactory for composite materials of substantial thickness, of the order for example of 20-25 mm for composite materials forming the rear layer of the composite assemblies for shielding, several textile plies are then impregnated individually then stuck together. In the manufacturing process according to the present invention, since 2.5D weaving produces an interlock fabric having a thickness varying up to several tens of millimetres, these steps of superposition and adhesion of the different plies to one another are eliminated, representing considerable savings in time and money. During thermal processing, the pressure exerted on the composite material under vacuum compacts it, thus improving impregnation of the first yarns.

The manufacturing process can be carried out continuously by arranging the means necessary for said thermal processing on completion of the 2.5D weaving step.

The applicant has surprisingly noticed that the composite materials obtained according to the present invention for ballisticproof protection are highly resistant to delamination, of particular advantage in the case of multi-impact shots. One explanation, not exclusive, is that said interlock fabric comprises first yarns impregnated at the core and the surface in the direction of its thickness which maintain the cohesion of the structure of said material under impact, and consequently reduce the delamination effects usually observed in the laminates of the prior art. Delamination must however be retained so that following impact the composite material does not disassemble totally. Advantageously, it has been observed with the composite material according to the present invention that the plies of the fibrous reinforcement delaminate progressively by sliding relative to one another in a controlled manner such that a ply adjacent to another ply is finally offset relative to this other ply, but still solid with the latter. In fact, the performance of said composite material can be broken down into three successive steps following impact. In a first step, the fibres at the periphery of the composite material are chiselled and cut. Next, the shockwave spreads in the adjacent plies, causing elongation of the fibres until they break. The composite material generally behaves like a spring and the projectile embeds itself in the thickness of the composite material by forming a tunnel. Finally, the yarns of inter-layer binding, that is, the warp yarns, block the delamination of the layers relative to one another and thus control inter-layer sliding. The composite material accordingly exhibits excellent resistance to delamination while enabling the composite material to delaminate in a controlled manner, of particular advantage in the case of multi-impact shots.

In composite materials comprising a fibrous reinforcement constituted by several distinct superposed plies, joined by adhesion for example, the resulting delamination is not controlled since the plies slide totally relative to one another, and the composite material can totally disassemble.

The plies of 2.5D fabric are connected by the warp yarns and not by the weft yarns by definition. In this way it is possible to exert prestress on the warp or weft yarns during the weaving operation to position the yarns in a better work configuration as a function of the mechanical stress envisaged during use of said composite material. By way of example, in the field of ballisticproof protection the fact of exerting prestress on the weft yarns, if possible equal to that exerted on the warp yarns for a number of warp yarns substantially equal to the number of weft yarns, produces rear deformation of the isodirectional composite material. It is however more difficult to control the stress placed on the weft yarns than on the warp yarns.

Said manufacturing process produces composite materials for ballisticproof protection especially in the following areas: protection of persons by means of vests, breastplates, headgear, and shielding of terrestrial vehicles (tanks, combat vehicles, . . . ), aerial vehicles (helicopters, transport aircraft, . . . ) and marine vehicles (assault ships of cruiser and destroyer type, aircraft carriers, submarines, . . . ). According to the nature, quantity and arrangement of said first and second yarns, the resulting composite material can also be used for making structural pieces having improved mechanical performance, especially in aeronautics and aerospace engineering.

For applications such as the protection of persons, the composite materials obtained according to the present invention can be utilised alone, not incorporated into composite assemblies, for protection against non-perforating bullets or against aggressions with a blade.

High-performance yarns are understood as yarns having a tenacity clearly greater than 60 cN/Tex. This value distinguishes the high-performance yarns from conventional yarns utilised especially in clothing, the tenacity of which is generally less than or equal to 60 cN/Tex. The first yarns are preferably selected from families of the following polymers, individually or mixed: aromatic polyamides such as para-aramide (poly-p-phenylene terephtalamide), meta-aramide (poly-m-phenylene isophtalamide), and copolymers of para-aramides; aromatic polyimides; high-performance polyesters, high-density polyethylene (HDPE); polybenzoxazoles such as PBO (p-phenylene benzobisoxazole) and PIPD (polypyridobisimidasole); polybenzothiazoles; and glass, especially of the trade mark S-2® marketed by the company AGY®.

Preferably, the first yarns for ballisticproof protection are yarns made of high-density polyethylene or fibreglass of the trade mark S-2®. HDPE yarns especially have a density of less than 1 g/cm³ ensuring their buoyancy, and especially a high elastic modulus, high tenacity and good resistance to abrasion. Also, the fibreglass of the trade mark S-2® has a very high transversal compression modulus as compared to organic fibres, offering it good aptitude to fragment perforating projectiles.

The first HDPE yarns are based on UHMWPE polymer (“Ultra High Molecular Weight PE”), and have a tenacity greater than 2 N/Tex, or even greater than 3 N/Tex according to grades.

In a variant, the first yarns have a tenacity greater than 1 Newton/Tex.

These first yarns having values of resistance to very high mechanical stresses are preferred in the textile reinforcements used in structural applications.

In a variant, the second yarns are in one or more families of the following polymers: polypropylene, low-density polyethylene, polyester and polyamide.

In a variant, the weaving pattern is of diagonal type, especially of diagonal type 5-4.

The weaving patterns known as diagonal ensure good dimensional stability to the textile reinforcement, especially during impact. In general, all the weaving patterns, especially of diagonal type, favouring floats and therefore minimising the bond points between the layers of the interlock fabric, also known as binding points, are preferred. In fact, during impact, the shockwave spreads in the yarns by coupling to the binding points. The waves are reflected and are superposed, causing the elongation of the first yarns forming the textile reinforcement until they break. The textile reinforcements having a limited number of binding points have better resistance to delamination and impact.

In a variant, the temperature T₀ of the thermal processing is comprised in the interval [T_{f2}+|T_{f1}−T_{f2}|/2; T_{f1}], in which the melting temperature of the second yarns T_{f2} is less than the melting temperature of the first yarns T_{f1}, so as to diminish the viscosity of the second melted yarns and improve impregnation of the first yarns.

The applicant has noted that the quality of impregnation positively influenced the mechanical qualities of the final composite material, and especially resistance to delamination.

In a variant, the manufacturing process according to the invention comprises an intermediate step, between the 2.5D weaving step and the thermal processing, such as described hereinabove, during which the following are superposed in this order: the textile reinforcement obtained following said 2.5D weaving step, a first layer made of a material based on meltable polymer, a second layer, preferably a layer of fabric made of para-aramide, a third layer made of a material based on meltable polymer, a fourth layer, especially made of a ceramic-based material; and in that during thermal processing said first and third layers melt and connect the resulting composite material to said second and fourth layers to form a composite assembly for ballisticproof protection.

Said first and third layers are preferably a polyurethane film.

Said second layer is preferably a fabric, such as a plain weave, based on para-aramide yarns. Said second layer is preferably calendered with a film of low-density polyethylene.

The fourth ceramic layer can be monolithic or formed from small squares, flat or curved.

In the composite assembly for ballisticproof protection, especially for the shielding, said composite material forms the rear layer, that is, the layer arranged in said assembly closest to the element to be protected, the human body for example in the case of bulletproof vests.

The aim of the present invention according to a second aspect is a composite material obtained by employing the manufacturing process described hereinabove, whereof the textile reinforcement comprises high-performance yarns selected from the following families of organic polymers, individually or mixed: aromatic polyamides such as para-aramide (poly-p-phenylene terephtalamide), meta-aramide (poly-m-phenylene isophtalamide), and copolymers of para-aramides; aromatic polyimides; high-performance polyesters, high-density polyethylene (HDPE); polybenzoxazoles such as PBO (p-phenylene benzobisoxazole) and PIPD (polypyridobisimidasole); polybenzothiazoles; or from the following fibres: glass, especially of the trade mark S-2®, carbon, alumine, silicon carbide, boron carbide.

The first yarns forming the textile reinforcement for ballisticproof protection are preferably yarns made of high-density polyethylene or fibreglass of the trade mark S-2®.

In a variant, the polymer matrix is thermoplastic, and represents by weight less than 30%, preferably less than 20%, of the total surface mass of said composite material.

The insertion technique by weaving of the polymer matrix in the interlock fabric optimises the necessary quantity of matrix. This arrangement lightens the surface mass of the composite material according to the invention relative to that of composite materials of the prior art having equal performance. The reinforcement rate is thus very high, of the order at least of 70%, preferably at least of the order of 80%, and confers high mechanical performances to structural pieces comprising said composite material.

In a variant, the polymer matrix is in one or more families of the following polymers: low-density polyethylene, polypropylene, polyamide, polyethylene terephthalate, and especially low-density polyethylene.

In a variant, said textile reinforcement is formed characteristically from a single fold of fabric.

The process according to the invention advantageously produces an interlock fabric in a single weaving operation having adjustable weight/m² and thickness, as well as a polymer matrix arranged at the core due to said woven second yarns.

In this way, said composite material is not formed from superposition of several plies, each ply being formed by an individual textile, but formed from a textile reinforcement comprising only a single ply made up of a multi-layer fabric.

The aim of the present invention according to a third aspect is a composite assembly for ballisticproof protection, the rear layer of which is formed by a composite material such as described hereinabove.

For ballisticproof protection, especially for protection against perforating bullets, the composite material according to the invention is employed as a rear layer in a composite assembly, the front layer of said ensemble preferably comprising a material having fragmentation properties of said bullets. Rear layer means that the composite material is placed in said assembly so as to be closest to the element to be protected, for example oriented towards the interior of the cockpit of a helicopter in the case of shielding of aerial vehicles.

Said composite assembly is utilised for shielding incorporated in personal equipment and especially in flexible vests, breastplates and headgear, or in the structural panels forming terrestrial vehicles (tanks, combat vehicles, etc.), aerial vehicles (helicopters, transport aircraft, etc.) and marine vehicles (aircraft carriers, etc.).

In a variant, the composite assembly comprises from back to front: a composite material, a first layer made of a material based on meltable polymer, a second layer, preferably comprising a layer of para-aramide fabric, a third layer made of a material based on meltable polymer, a fourth layer, especially of a ceramic-based material.

The fourth layer is placed so as to directly oppose possible impact when said composite assembly is utilised, and its purpose is to fragment hard-cored ammunition of perforating bullets and reduce the kinetic energy associated with impacts.

In a variant, the composite material has a surface mass of the order or less than 11,000 g/m².

Since incorporating the polymer matrix is easier to master because it takes place during weaving, its quantity is optimised. The applicant has accordingly developed a composite material used as a rear layer in a composite assembly for shielding having a surface mass of the order of 10% less than the surface mass of equivalent composite materials in terms of performance. This arrangement has considerable energy savings, especially for protection of aerial vehicles, and prevents wear on mechanical parts (shock absorbers, . . . ) of terrestrial vehicles.

### BRIEF DESCRIPTION OF THE DRAWINGS

The present invention will be better understood from an embodiment of a composite material for ballisticproof protection, cited as non-limiting, and illustrated in the following figures, attached to the present specification, in which:

FIG. 1 is a schematic representation illustrating the 2.5D weaving principle used within the scope of the present invention;

FIG. 2 illustrates the weaving pattern of an example of interlock fabric according to the present invention,

FIG. 3 illustrates the reading table of the structure of the interlock fabric whereof the base weave is illustrated in FIG. 2;

FIG. 4 is a section according to the warp direction of the interlock fabric illustrated in FIGS. 2 and 3;

FIG. 5 is a schematic representation of a composite assembly for ballisticproof protection comprising a composite material whereof the plies are formed from the interlock fabric described in FIGS. 2 to 4.

### DETAILED DESCRIPTION

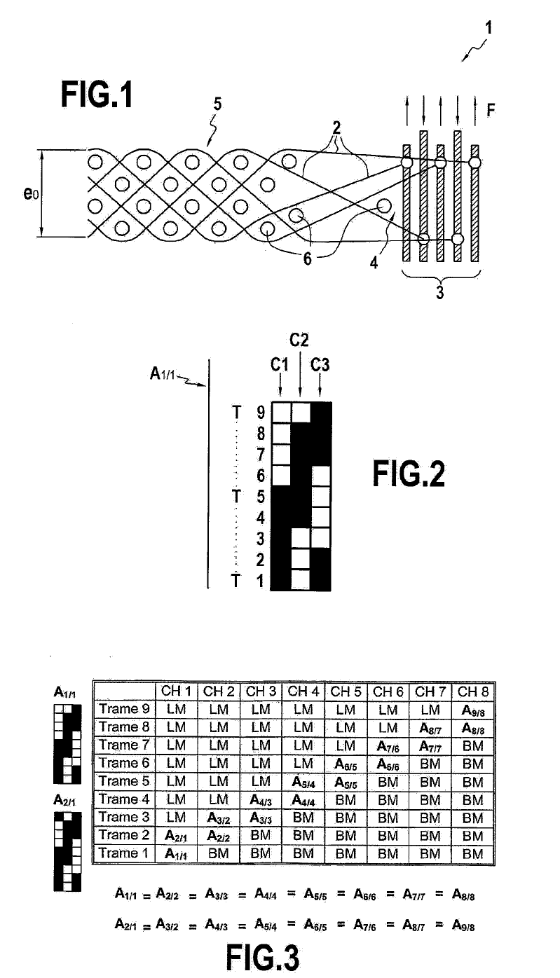

The weaving loom 1 represented partially in FIG. 1 manages five warp 2. During vertical movement F of the frames 3, supporting the healds in which the warp yarns are inserted, several warp 2 can be shifted upwards at the same time to form a single shed 4. The interlock fabric 5 is formed in this example of five layers 2 of warp yarns and weft yarns 6. These layers 2 are in turn connected to each other by chain yarns. The weft yarns 6 are inserted into the thickness e₀ of the interlock fabric 5.

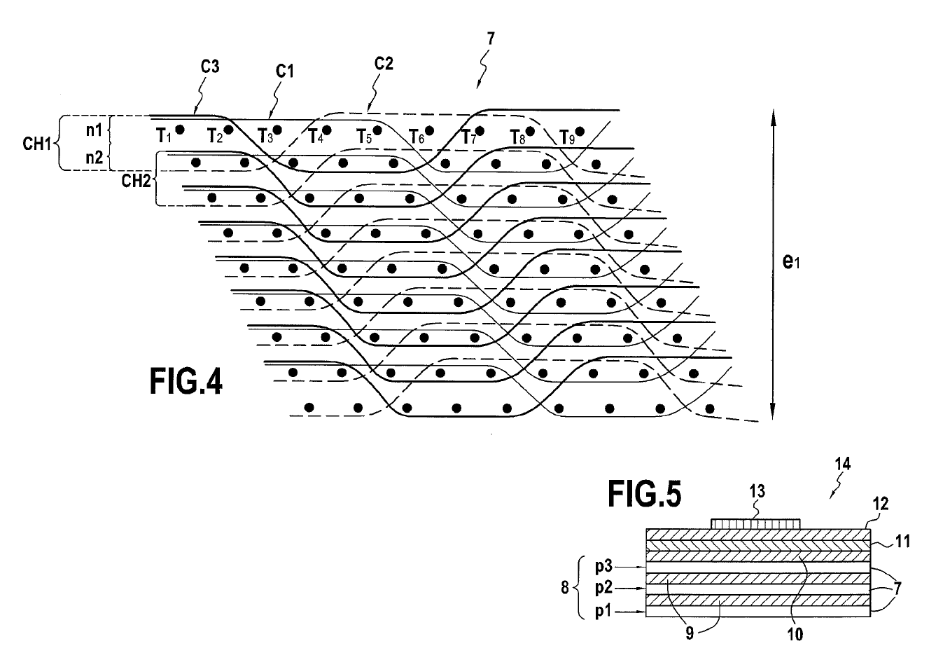

The base weaving pattern A_{1/1} shown in FIG. 2 is a diagonal 5-4 with a step number of 3. The step number is the offset from one weft pick to another. In general, the number of layers of chain yarns is equal to the number of blades available on a weaving loom divided by the width connection of the selected weave. The weaving loom utilised in this embodiment, not shown here, comprises 24 blades. The blades are the frames supporting the healds. The interlock fabric 7, obtained by using the base weaving pattern A_{1/1} and shown in FIG. 4, comprises eight layers of chain yarns CH1 to CH8 woven with nine weft picks T1 to T9 whereof three chain yarns are woven per layer. The chain yarns C₁ to C₃ correspond to the layer CH1 of the interlock fabric 7 according to the table shown in FIG. 3, and more particularly are woven according to the weaving pattern A_{1/1} also shown in FIG. 2. The diagonal weaves have a height connection, here nine, much greater than the width connection, here three, if the step number divides the height connection. This type of weave comes close to the structure of the unidirectional textile reinforcements by minimising the number of binding points.

FIG. 2 shows that the chain yarn C1 passes above the weft picks T₁ to T₅ then under the weft picks T₆ to T₉. The chain yarn C1 crosses only four weft picks, between T₅ and T₆ and T₉ and T₁, out of nine weft picks, corresponding to two binding points or binding points out of nine or around 22% of binding points. The same goes for the chain yarns C2 and C3. The interlock fabric 7 comprises a low binding rate of the order of 22%. This binding rate ensures good dimensional stability for the interlock fabric 7 used as textile reinforcement during impact. Also, it decreases the coupling of shock waves at the binding points following impact and therefore improves resistance to delamination, particularly in the case of multi-impact shots.

In FIG. 3, the abbreviations LM and BM at the intersection of the boxes comprising the abbreviations CH1 to CH8 for the chain layers one to eight and the weft yarns T₁ to T₉ correspond respectively to raising mass and lowering mass. Raising mass and lowering mass respectively mean the raising and lowering of the frames supporting the healds.

FIG. 4 shows the interlock fabric 7 according to a longitudinal section. The layer CH1 of said fabric 7 is formed from chain yarns C1 to C3, and is connected to the layer CH2 by these same chain yarns. There are two distinct levels of weft, n1 and n2 for the layer CH1 characteristics of the weft double-face fabrics. This evolution is repeated eight times in the direction of the thickness e₁ of the fabric 7 since there are eight chains.

The capacity of a yarn to propagate a wave is very important in the field of ballisticproof protection, as it dissipates the kinetic energy due to shock(s) more or less rapidly. The propagation velocity of a shockwave applied longitudinally to a yarn is calculated by the following equation: V1=root (E/d) where E is the elastic modulus in Pa of the yarn and d the density in kg/m³ of said yarn. Yarns having a propagation velocity greater than 10,000 m/s are yarns made of high-density polyethylene; yarns made of para-aramide and yarns made of glass, especially of the trade mark S-2®, have as such a considerable propagation velocity since it is greater than 8,000 m/s.

In this particular embodiment, the chain yarns C₁ to C₂₄ are the first yarns and are preferably yarns made of high-density polyethylene, such as those marketed under the Spectra® brand by the company HoneyWell®. By way of example the first yarns respectively exhibit tenacity, resistance to breaking and an elastic modulus of 2.52 GPa, 2.31 GPa, and 62 GPa.

The second thermofusible yarns are inserted in weft, and preferably one yarn out of four of the weft yarns T₁ to T₉ is a second thermofusible yarn. Preferably, the second yarns are made of low-density polyethylene, and by way of example have resistance to breaking, breaking elongation and a Young's module respectively of 8 MPa, 200% and 170 MPa.

The linear density of the first and second yarns is determined such that the interlock fabric 7 has a surface mass of the order of 3660 g/m² whereof 2930 g/m² for the first yarns formed by the yarns in HDPE and 730 g/m² for the second yarns formed by the thermofusible yarns in PEBD. The surface mass in second yarns is of the order of 20% of the total surface mass of the interlock fabric 7. The interlock fabric leaving the loom has a thickness e1 of the order of 7 mm.

The composite assembly 14 illustrated in FIG. 5 is utilised for shielding, that is for protection from perforating ammunition such as described above. It comprises a composite material 8 formed in this order of three plies p1, p2 and p3, each comprising a layer of interlock fabric 7 and interleaved with a thermofusible film 9 for adhesion. The composite material 8 forms the rear layer of the composite assembly 14. The composite assembly 14 also comprises, arranged on the ply p3, a first layer 10 made of a material based on meltable polymer, a second layer 11 made of a fabric made of calendered para-aramide with a LDPE film, a third layer 12 made of a material based on meltable polymer, a fourth layer 13 in ceramic. The layers 9, 10 and 12 are made of a film of thermofusible polyurethane. The fourth layer 13 is formed from four squares of alumine placed in a staggered array, not shown here. The composite assembly 14 then undergoes a vacuum bagging step consisting of placing on the assembly 14 a felt then an auto-mould-releasing film and a canvas cover, not shown. Once said canvas cover is made impervious by means known from the prior art, the of the assembly is carried out and its purpose is to compact the assembly, especially the plies p1 to p3 with the ceramic squares. The assembly 14 is then subjected to thermal processing having a processing temperature of between 100° C. and 130° C., for at least two hours, preferably at least four hours, at a pressure greater than 5 bars, preferably equal to or greater than 10 bars. In this example, the processing temperature is less than the glass transition temperature of the yarns made of high-density polyethylene so as not to degrade the latter.

The composite assembly 14 once baked is removed from the mould. The composite material 8 has a surface mass of the order of 11,000 g/m², the polymer matrix formed by the second melted yarns represents 20% of the total surface mass of the composite material 8. The three plies p1 to p3 each formed from a layer of interlock fabric 7 and interleaved with the films 9 have a thickness of the order of 20 mm. The temperature T₀ of the thermal processing is determined to produce fusion of the second yarns without impairing the first yarns. Preferably, T₀ is in the interval [T_{f1}+|T_{f1}−T_{f2}|/2; T_{f1}], in which the melting temperature of the second yarns T_{f2} is less than the melting temperature of the first yarns T_{f1} so as to decrease the viscosity of the second melted yarns and improve impregnation of the first yarns.

The layer 13 is that placed to be touched first by impact when the composite assembly 14 is used, the composite material 8 oriented to the element to be protected.

The composite assembly 14 was subjected to impact according to the standard MIL-PRF-46103E with a perforating bullet of 12.7 mm calibre (weight: 43 g). The velocity of the bullet must be of the order of 610 m/s according to the above standard. The impact formed a hole whereof the diameter is between 120 and 150 mm and whereof the depth is between 20 and 25 mm. The composite assembly 14, having a thickness of 30 mm, stopped the bullet. During analysis of the composite assembly 14, after at least the layers 11 to 13 have been removed, the impact left at the surface of the ply p3 on the composite material 8 is very clear compared to that left on the composite reference assembly formed from 48 superposed UD plies of HDPE and stuck with LDPE films. The substantial thickness of the textile reinforcement forming the ply p3, of the order of one layer of interlock fabric 7, prevents the former from being torn off with the ceramic layer 13 under the shockwave. In the composite reference assembly the surface subjected to impact, once the ceramic defragmentation layer is removed, has burst yarns and highly deformed zones. By way of difference, slight delamination between the plies p1, p2 and p3 sufficient to absorb kinetic energy due to impact though limited so as to minimise possible dislocation of the composite material 8. The delamination behaviour of the composite material 8 is improved by directly weaving an interlock fabric having a surface mass of the order of 11,000 g/m² whereof 20% is formed by second thermofusible yarns. The rear layer of the reference composite assembly has a surface mass of the order of 10% greater than that of the composite material 8.

1. A manufacturing process of composite material, comprising a textile reinforcement and a polymer matrix ballisticproof protection comprising:
forming the textile reinforcement by 2.5D weaving of first yarns with second yarns according to a determined weave (A_{1/1}), said second yarns being made of thermofusible polymer and said first yarns being high-performance yarns to produce an interlock fabric,
followed by thermal processing during which said interlock fabric is subjected to temperature and pressure conditions determined so as to melt said second yarns to form the polymer matrix, without altering the first yarns.

2. The manufacturing process as claimed in claim 1, wherein the first high-performance yarns have a tenacity of greater than 1 Newton/Tex.

3. The manufacturing process as claimed in claim 1, wherein the second yarns are in one or more families of the following polymers: polypropylene, low-density polyethylene, polyester and polyamide.

4. The manufacturing process as claimed in claim 1, wherein the weaving pattern is of diagonal type, especially of diagonal type 5-4 (A_{1/1}).

5. The manufacturing process as claimed in claim 1, wherein the temperature T₀ of the thermal processing is in the interval [T_{f2}+|T_{f1}−T_{f2}|/2; T_{f1}], in which the melting temperature of the second yarns T_{f2} is less than the melting temperature of the first yarns T_{f1}, so as to diminish the viscosity of the second melted yarns and improve impregnation of the first yarns.

6. The process as claimed in claim 1 for making a composite assembly (14) for ballisticproof protection, further comprising an intermediate step, between the 2.5D weaving step and the thermal processing, during which the following are superposed in this order: the textile reinforcement obtained following said 2.5D weaving step, a first layer in a material based on meltable polymer, a second layer, preferably comprising a layer of para-aramide fabric, a third layer in a material based on meltable polymer, a fourth layer, especially made of a ceramic-based material; and in that during thermal processing said first and third layers melt and connect the resulting composite material to said second and fourth layers so as to form said ensemble.

7. A composite material obtained by the manufacturing process as claimed in claim 1 wherein the textile reinforcement comprises high-performance yarns selected from the families of the following organic polymers, individually or mixed: aromatic polyamides such as para-aramide (poly-p-phenylene terephtalamide), meta-aramide (poly-m-phenylene isophtalamide), and copolymers of para-aramides; aromatic polyimides; high-performance polyesters, high-density polyethylene (HDPE); polybenzoxazoles such as PBO (p-phenylene benzobisoxazole) and PIPD (polypyridobisimidasole); polybenzothiazoles; or fibreglass.

8. The composite material as claimed in claim 7, wherein the polymer matrix is thermoplastic, and by weight represents less than 30%, preferably less than 20%, of the total surface mass of said composite material.

9. The composite material as claimed in claim 7 wherein the polymer matrix is in one or more families of the following polymers: low-density polyethylene, polypropylene, polyamide, polyethylene terephthalate, and especially made of low-density polyethylene.

10. The composite material as claimed in claim 7 wherein the textile reinforcement is formed by a single fold of fabric.

11. A composite assembly for ballisticproof protection whereof the rear layer is formed by a composite material as claimed in claim 7.

12. The composite assembly as claimed in claim 11, further comprising from back to front:
a composite material,
a first layer in a material based on melting polymer,
a second layer comprising a layer of para-aramide fabric,
a third layer made of a material based on melting polymer, and
a fourth layer made of a ceramic-based material.

13. The composite assembly as claimed in claim 1 wherein the composite material has a surface mass of the order of or less than 11,000 g/m².
